(19) United States
(12) Patent Application Publication
(10) Pub. No.: US 2003/0204718 A1
(43) Pub. Date: Oct. 30, 2003

(54) Architecture containing embedded compression and encryption algorithms within a data file

(75) Inventors: William G. Connelly, Vista, CA (US); Bernard Mark Gudaitis, Palos Verdes Estates, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/425,326

(22) Filed: Apr. 29, 2003

Related U.S. Application Data
(60) Provisional application No. 60/376,243, filed on Apr. 29, 2002.

(51) Int. Cl. H04L 9/00

(52) U.S. Cl. 713/150; 705/50

(57) ABSTRACT

Digital media content is processed in a computer system. The computer system comprises a first general purpose processor and a second co-processor in the computer system. The second co-processor is configured to perform common but relatively complex subroutines. Digital media content is encrypted into a data file in accordance with an encryption/decryption algorithm. Metadata for the data file also includes the encryption/decryption algorithm. The data file is then transmitted and received at a displaying entity where the encryption/decryption algorithm is utilized to decrypt the media content for display.

### CROSS-REFERENCE TO RELATED APPLICATIONS

This application claims the benefit under 35 U.S.C.§119(e) of the following co-pending and commonly-assigned U.S. provisional patent applications which is incorporated by reference herein:

U.S. Provisional Patent Application Serial No. 60/376,243, filed Apr. 29, 2002, by inventors William G. Connelly and Bernard Mark Gudaitis, entitled ARCHITECTURE CONTAINING EMBEDDED COMPRESSION AND ENCRYPTION ALGORITHMS WITHIN THE DATA FILE, attorneys' docket number G&C 147.0096-US-P1.

This application is related to the following co-pending and commonly-assigned patent applications, which applications are incorporated by reference herein:

U.S. Provisional Patent Application Serial No. 60/376,105, filed Apr. 29, 2002, by inventor Charles F. Stirling, entitled SECURE DATA CONTENT DELIVERY SYSTEM FOR MULTIMEDIA APPLICATIONS UTILIZING BANDWIDTH EFFICIENT MODULATION, attorneys' docket number G&C 147.0068-US-P1,

U.S. Provisional Patent Application Serial No. 60/376,244, filed Apr. 29, 2002, by inventors Ismael Rodriguez and James C. Campanella, entitled METHOD TO SECURELY DISTRIBUTE LARGE DIGITAL VIDEO/DATA FILES WITH OPTIMUM SECURITY, attorneys' docket number G&C 147.0101-US-P1,

U.S. Provisional Patent Application Serial No. 60/376,254, filed Apr. 29, 2002, by inventor Michael A. Enright, entitled METHOD TO DECOMPRESS AND MULTIPLEX MULTIPLE VIDEO STREAMS IN REAL-TIME, attorneys' docket number G&C 147.0080-US-P1,

U.S. Provisional Patent Application Serial No. 60/376,085, filed Apr. 29, 2002, by inventors David Kung and William G. Connelly, entitled METHOD AND APPARATUS TO INSTALL DIGITAL CINEMA PROJECTORS PROVIDING DUAL USE OF OPTICS AND SPACE, attorneys' docket number G&C 147.0098-US-P1;

### BACKGROUND OF THE INVENTION

1. Field of the Invention

The present invention relates generally to systems and methods for efficient very large data file transfers, and in particular, to a method, system, apparatus, and article of manufacture for such transfers in digital cinema systems.

2. Description of the Related Art

There is often a need to electronically transfer very large data files. For example in digital cinema systems, audio and video data (e.g., movies) exceeding 50 gigabytes (GB) may need to be electronically transmitted and received. To preserve the intellectual property and other interests in the data, the data must be protected. Accordingly, very large data files requiring protection are encrypted and compressed for transport from content providers to users. Robust security methods require computationally intense techniques to prepare the data prior to transport and at end use. These techniques require point (hardware specific) solutions due to the unique nature of the security methods (algorithms) employed and the limited time available to complete the data preparation. However, such hardware specific solutions used by both the content provider (to encrypt the data) and user (to decrypt the data) are expensive and inflexible.

The early applications of very large (larger than 50 GB) data file transfers (e.g., in digital cinema applications) have employed custom solutions using video based equipment modified to support the larger files. Due to existing processor capabilities, these solutions have involved hardware specific designs that are incapable of processing different/varying and/or competitive compression and/or encryption algorithms. These specifically designed unique hardware systems are the only option to customers presently, and adoption of such systems has been limited due to uncertainty over the future standard selected. Accordingly, what is needed is a flexible hardware solution that provides the ability to utilize most known algorithms as well as support for future developments/algorithms.

Current designs for a theater sub-system in digital cinema systems comprise a firmware solution to decompress and decrypt data due to the computing speed and complexity required to prepare a large (e.g., 50 GB) compressed, encrypted file for projection. Most of these solutions are proprietary and exclusive, creating a standards problem for the industry.

Thus, there is a need for systems and methods which enable efficient large data file transfers. There is further a need for such systems and methods without creating standards conflicts across different systems and hardware. There is particularly a need for such systems and methods in digital cinema applications. A flexible, cost effective hardware independent solution would enable the use of various compression/encryption technologies over the same system.

### SUMMARY OF THE INVENTION

Very large data files requiring protection are encrypted and compressed for transport from content providers to users. Robust security methods require computationally intense techniques to prepare the data prior to transport and at end use. These techniques require point (hardware specific) solutions due to the unique nature of the security methods (algorithms) employed and the limited time available to complete the data preparation.

One or more embodiments of the invention provide a flexible, cost effective hardware independent solution would enable the use of various compression/encryption technologies over the same system. Embodiments of the invention provide an architecture containing embedded compression/encryption algorithms within the data file (i.e., as metadata). The algorithm is then utilized by a user to decrypt accompanying media content. As a result, no additional software or hardware is required by a user.

### BRIEF DESCRIPTION OF THE DRAWINGS

Referring now to the drawings in which like reference numbers represent corresponding parts throughout:

FIGS. 1A and 1B depict a top-level functional block diagram of one embodiment of a media program distribution system in accordance with one or more embodiments of the invention;

FIG. 2 is a functional block diagram of a computer system utilized in accordance with one or more embodiments of the invention; and

FIG. 3 is a flow chart illustrating the logical flow for processing digital media content in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

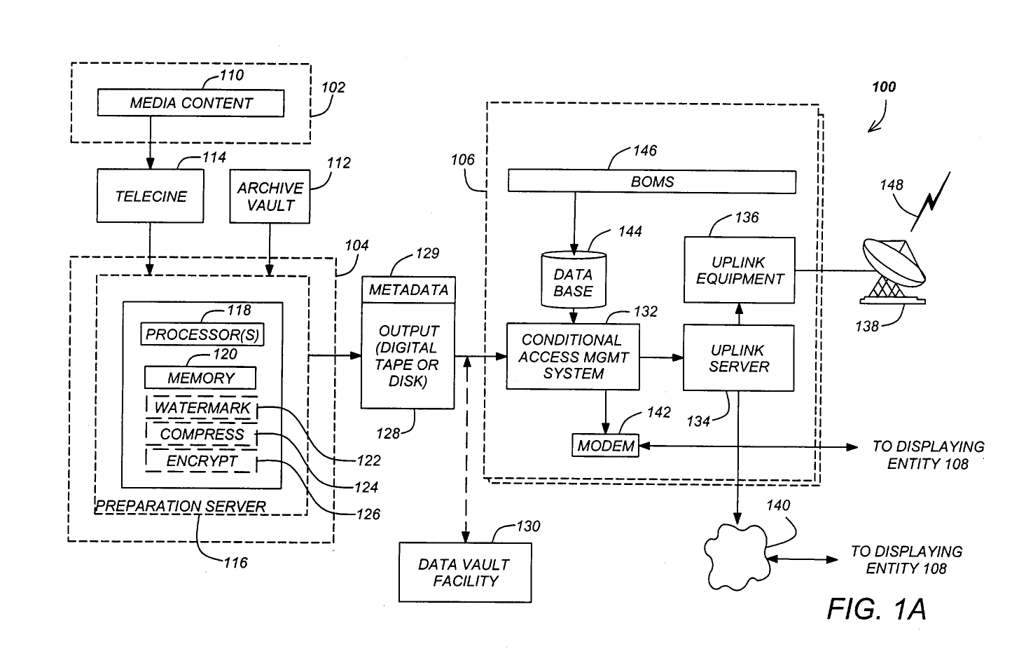

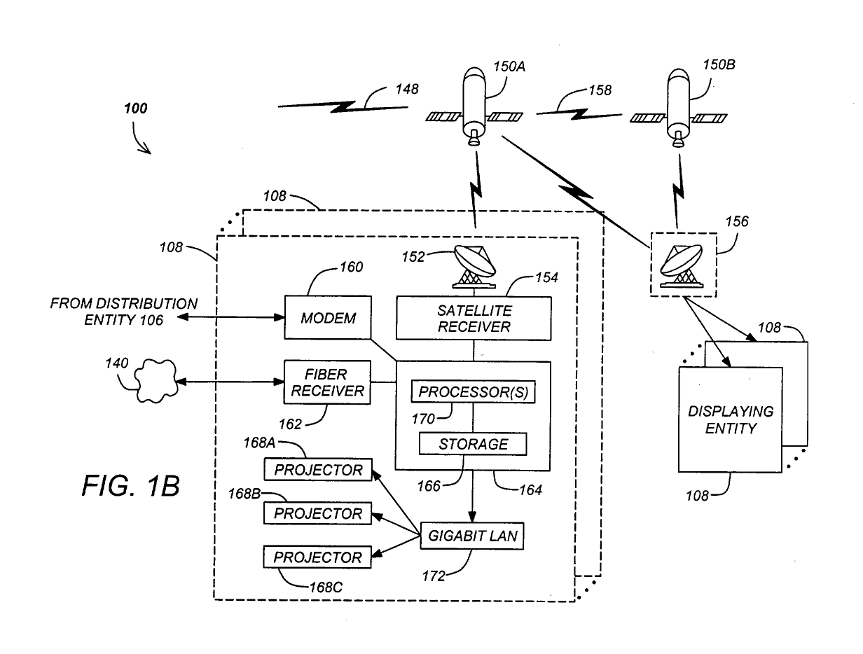

FIGS. 1A and 1B depict a top-level functional block diagram of one embodiment of a media program distribution system 100. The media distribution system 100 comprises a content provider 102, a protection entity 104, a distribution entity 106 and one or more presentation/displaying entities 108. The content provider 102 provides media content 110 such as audiovisual material to the protection entity 104. The media content 110, which can be in digital or analog form, can be transmitted in electronic form via the Internet, by dedicated land line, broadcast, or by physical delivery of a physical embodiment of the media (e.g. a celluloid film strip, optical or magnetic disk/tape). Content can also be provided to the protection entity 104 (also referred to as a preparation entity) from a secure archive facility 112.

The media content 110 may be telecined by processor 114 to format the media program as desired. The telecine process can take place at the content provider 102, the protection entity 104, or a third party.

The protection entity 104 may include a media preparation server 116. In one embodiment, the media preparation server 116 includes a computer system such as a server, having one or more processors 118 and a memory 120 communicatively coupled thereto. The protection entity 104 further prepares the media content 110. Such preparation may include adding protection to the media content 110 to prevent piracy of the media content 110. For example, the preparation server 116 can add watermarking 122 and/or encrypt 126 the media content 110 to protect it. In addition, the preparation server can also apply compression 124 to the media content 110. As described above, in the prior art, the compression 124 or encryption 126 applied to the media content 110 in the prior art was implemented using a custom hardware solution. In the present invention, such a custom hardware solution is not required.

Once prepared, the output media content 128 can be transferred to digital tape or a disk (e.g. a DVD, laserdisk, or similar medium). The output media content 128 can then be archived in a data vault facility 130 until it is needed. In addition to the output media content 128 (or as part of the output media content 128), metadata 129 may be provided or accompany the output media content 128. The metadata 129 contains the decompression/decryption algorithm for the data file.

When needed, the prepared output media content 128 and metadata 129 are then provided to the distribution entity 106 (alternatively referred to hereinafter as the network operations center [NOC]). Although illustrated as separate entities, the protection entity 104 and the distribution entity 106 can be combined into a single entity, thus ameliorating some security concerns regarding the transmission of the output media content 128 and metadata 129.

The distribution entity 106 includes a conditional access management system (CAMS) 132 (also referred to as a configuration management engine), that accepts the output media content 128 and metadata 129, and determines whether access permissions are appropriate for the content 128 and metadata 129. In this regard, the metadata 129 may contain relevant information that is used in this determination. Further, CAMS 132 may be responsible for additional encrypting so that unauthorized access during transmission is prevented.

Once the data is in the appropriate format and access permissions have been validated, CAMS 132 provides the output media content 128 and metadata 129 to an uplink server 134, ultimately for transmission by uplink equipment 136 to one or more displaying entities 108 (also referred to as exhibitor systems) (shown in FIG. 1B). This is accomplished by the uplink equipment 136 and uplink antenna 138. Also, as shown, in addition or in the alternative to transmission via satellite, the media program can be provided to the displaying entity 108 via a forward channel fiber network 140. Additionally, information may be transmitted to displaying entity 108 via a modem 142 using, for example a public switched telephone network line. A land based communication such as through fiber network 140 or modem 142 is referred to as a back channel. Thus, information can be transmitted to and from the displaying entity 108 via the back channel or the satellite network. Typically, the back channel provides data communication for administration functions (e.g. billing, authorization, usage tracking, etc.), while the satellite network provides for transfer of the output media content 128 and metadata 129 to the displaying entities 108. Alternatively, the output media content 128 may be delivered via satellite with the metadata 129 delivered via the back channel.

The output media content 128 may be securely stored in a database 144. Data is transferred to and from the database 144 under the control and management of the business operations management system (BOMS) 146. Thus, the BOMS 146 manages the transmission of information to 108, and assures that unauthorized transmissions do not take place. In this regard, the metadata 129 may or may not be stored in database 144. For security reasons, the system 100 may provide that the metadata 129 (or the algorithm within the metadata 129) is not stored.

Turning to FIG. 1B, the data transmitted via uplink 148 is received in a satellite 150A, and transmitted to a downlink antenna 152, which is communicatively coupled to a satellite or downlink receiver 154.

In one embodiment, the satellite 150A also transmits the data to an alternate distribution entity 156 and/or to another satellite 150B via crosslink 158. Typically, satellite 150B services a different terrestrial region than satellite 150A, and transmits data to displaying entities 108 in other geographical locations.

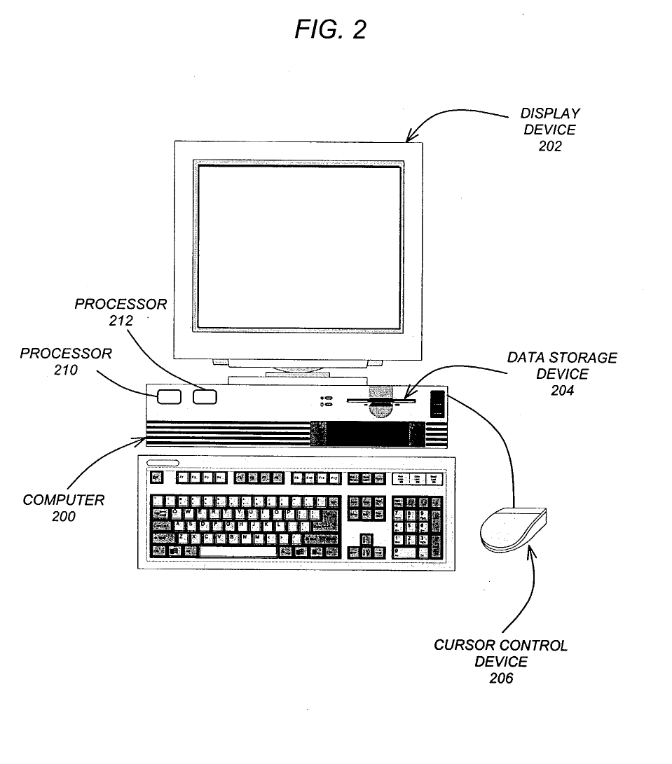

A typical displaying entity 108 comprises a modem 160 (and may also include a fiber receiver 162) for receiving and transmitting information through the back channel (i.e., via an communication path other than that provided by the satellite system described above) to and from the distribution entity 106. For example, feedback information (e.g. relating to system diagnostics, billing, usage and other administrative functions) from the exhibitor 108 can be transmitted through the back channel to the distribution entity 106. The output media content 128, metadata 129, and other information may be accepted into a processing system 164 (also referred to as a content server) such as a server or computer similar to that which is illustrated in FIG. 2 (see description below). The output media content 128 may then be stored in the storage device 166 for later transmission to displaying systems (e.g., digital projectors) 168A-168C. Before storage, the output media content 128 can be decrypted to remove transmission encryption (e.g. any encryption applied by the CAMS 132), leaving the encryption applied by the preparation processor 116.

As described above, metadata 129 (or the algorithm within metadata 129) may not be stored or reside in a storage device 166. Instead, the metadata 129/algorithm may be received, used, and destroyed so that it does not reside within display entity 108 and cannot be transferred or unlawfully used. Alternatively, the metadata 129/algorithm may be stored in storage device 166. In such an embodiment, an identifier for the metadata 129/algorithm may be associated with the metadata 129/algorithm. Thereafter, whenever the algorithm is needed, the display entity 108 merely receives the identifier for the appropriate output media content 128 and utilizes the associated algorithm to decrypt/decompress the output media content 128 to obtain the media content 110 for display.

Accordingly, when the media content 110 is to be displayed, final decryption techniques are used on the output media content 128 to substantially reproduce the original media content 110 in a viewable form which is provided to one or more of the displaying systems 168A-168C. For example, encryption 126 and compression 124 applied by the preparation processor 118 is finally removed, however, any latent modification, undetectable to viewers (e.g., watermarking 122) is left intact. As described above, the decryption/decompression algorithms may be received in metadata transported with/within output media content 128.

In one or more embodiments, one or more display processors 170 prevents storage of the decrypted media content in any media, whether in the storage device 166 or otherwise. In addition, the media content 110 can be communicated to the displaying systems 168A-168C over an independently encrypted connection, such as on a gigabit lan 172.

FIG. 2 is a functional block diagram of a computer system 200 that can be used to perform the operations of the media preparation server 116 and processing system 164. Embodiments of the invention are typically implemented using a computer 200, which generally includes, inter alia, a display device 202, data storage devices 204, cursor control devices 206, and other devices. Those skilled in the art will recognize that any combination of the above components, or any number of different components, peripherals, and other devices, may be used with the computer 100.

As described above, the computer system 200 is independent of the decompression/decryption approach and allows studios/content providers to select/implement compression technologies at will. Computer system 200 comprises a parallel general purpose parallel processor 210 coupled with a unique co-processor 212 based on specific subroutines found in current/available compression and encryption algorithms. The co-processor 212 functions as an accelerator for computationally intensive subroutines so files can be encrypted and compressed on the transmit link (i.e., by preparation server 116) as well as decompressed and decrypted on the receive link (i.e., display entity 108) at or faster than the streaming rate of the data 128.

Similar designs have been developed for narrow-band applications such as digital radio (multi-mode demodulation of various waveforms on a common platform), but all current high-data rate, broadband systems in use utilize proprietary hardware specific solutions. However, this invention utilizes the architecture of a hybrid, general purpose DSP (digital signal processor) 210 and a co-processor 212. The co-processor 212 performs common but relatively complex subroutines that would consume excessive time if processed on the DSP 210. In this regard, the co-processor may solely function as an accelerator for subroutines that are commonly applied to compression or encryption processes.

The combination of co-processor 212 and the DSP 210 allows the designer to send software that programs the basic routines to be accomplished quickly in the co-processor while the unique routines are handles by the DSP. Such processing could all be performed in the DSP 210 if the DSP 210 were able to run fast enough. Accordingly, the co-processor 212 is simply wired to save many clock cycles (and therefore time) in completing computations.

In one or more embodiments, the co-processor 212 design is independent of the source or transmission path of the file. In such an embodiment, the co-processor would execute similarly regardless of whether the transmission is conducted through satellite, optical fiber, or hard media. Alternatively, the co-processor design may be focused on broadband, data transport over satellite 150 at rates capable of supporting live streaming of content over satellite 150 for cinema motion picture multicast distribution applications (i.e., the design may be based on timing and data transfer issues and not focused on a particular encryption/compression scheme).

As described above, similar designs have been developed for narrow-band applications such as digital radio. However, the present invention provides a design for wide-band applications such as digital cinema utilizing general purpose processors 210-212.

Embodiments of the invention ate particularly useful in a digital cinema system 100, such as that previously detailed. An open architecture distribution system for the digital cinema system 100 is enabled. This is a cost effective hardware solution that enables the use of various compression/encryption technology over the same system 100.

Programs executing on the computer 200 (such as an operating system) are comprised of instructions which, when read and executed by the computer 200, causes the computer 200 to perform the steps necessary to implement and/or use the present invention. Computer programs and/or operating instructions may also be tangibly embodied in a memory and/or data communications devices of the computer, thereby making a computer program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

Logical Flow

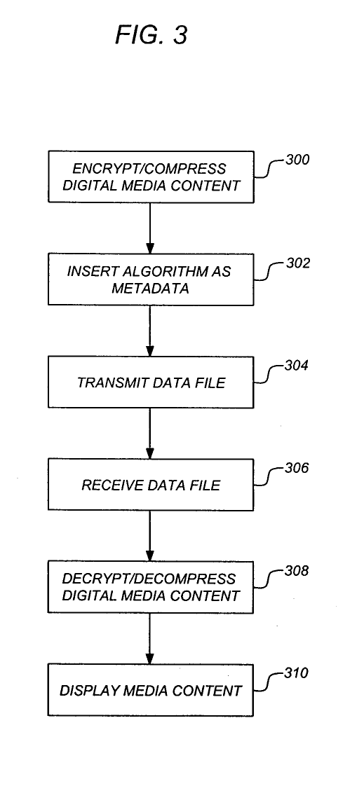

FIG. 3 is a flow chart illustrating the logical flow for processing digital media content 110 in accordance with one or more embodiments of the invention. The logical flow is based on the premise that an effective independent hardware solution may be utilized. In other words, as described above, a computer system of the invention is comprised of a general purpose parallel processor coupled with a co-processor that is not dependent on and that has not been specifically designed for a particular encryption/compression algorithm. In this regard, the first processor may be a general purpose digital signal processor (DSP) or an application specific integrated circuit (ASIC). Additionally, the design of the co-processor is focused on providing an accelerator for various processes.

At step 300, digital media content 110 is encrypted into a data file. As used herein, the term encrypting includes encoding, compressing, or any other translating of the digital media content 110. The encryption of the digital media content 110 is performed in accordance with an encryption/decryption algorithm. The encryption/decryption algorithm utilized is not hardware dependent and may change depending on the media content 110. For example, a different algorithm may be utilized for different movies or programming.

At step 302, the encryption/decryption algorithm utilized to encrypt the digital media content 110 is inserted as metadata 129 into the data file. In other words, metadata 129 that describes the encrypted content 128 includes the algorithm utilized to encrypt the content 110. By providing the algorithm in the metadata 129, the algorithm may be changed whenever desired/necessary by the content provider 102. Accordingly, different media content 110 may be encrypted into the data file in accordance with a different encryption/decryption algorithm. In such a situation the different encryption/decryption algorithm is also inserted into the data file.

Alternatively, if the different encryption/decryption algorithm is merely an improvement of a previously used algorithm, the information necessary to update the encryption/decryption algorithm at the display entity 108 (if the algorithm is stored at the display entity 108) may merely be inserted into the data file.

At step 304, the data file (which includes the encrypted media content 128 and algorithm within the metadata 129) is transmitted to a distribution entity 106 for further transmission via satellite 138 to a display entity 108. At step 306, the display entity 108 receives the data file. At step 308, the computer system 164 in the display entity 108 decrypts the digital media content 128 in accordance with the algorithm provided in the metadata 129. Once decrypted/decompressed, the digital media content 110 may be displayed by display entity 108 (e.g., using projectors 168 in a digital cinema).

Once the digital media content 110 has been decrypted at the display entity 108, various alternatives may be implemented in accordance with the invention. For example, the encryption/decryption algorithm may be destroyed to further ensure the safety/security of the digital media content 110 and the algorithm. Alternatively, the encryption/decryption algorithm may be stored in storage 166. If the algorithm is stored, the content provider merely needs to transmit an identifier associated with the appropriate algorithm in the metadata 129. The transmission of such an identifier in the metadata 129 allows the display entity 108 to identify the appropriate encryption/decryption algorithm for use in decrypting the encrypted media content 128 received.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide a hardware independent solution for processing digital media content. More specifically, a hardware solution that is not uniquely designed for a particular encryption algorithm is utilized prior to content transmission and at a display entity. To utilize. the general purpose hardware solution, the algorithm utilized to encrypt media content is merely attached as metadata with the encrypted media content during transmission. Once received, the algorithm may be utilized by the general purpose computer at the display entity for decrypting the media content.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for processing digital media content in a computer system wherein the computer system comprises a first general purpose processor and a second co-processor on the computer, wherein the second co-processor is configured to perform common but relatively complex subroutines, the method comprising:
encrypting digital media content into a data file in accordance with an encryption/decryption algorithm;
inserting the encryption/decryption algorithm as metadata into the data file; and
transmitting the data file.

2. The method of claim 1, wherein the first processor is a general purpose digital signal processor (DSP).

3. The method of claim 1, wherein the first processor is an application specific integrated circuit (ASIC).

4. The method of claim 1, wherein the data file is transmitted to a distribution entity for subsequent transmission to a displaying entity.

5. The method of claim 1 further comprising:
encrypting different media content into the data file in accordance with a different encryption/decryption algorithm; and
inserting the different encryption/decryption algorithm into the data file.

6. A method for processing digital media content in a computer system wherein the computer system comprises a first general purpose processor and a second co-processor on the computer, wherein the second co-processor is configured to perform common but relatively complex subroutines, the method comprising:
(a) receiving a data file, wherein the data file comprises:
(i) media content compressed in accordance with an encryption/decryption algorithm, and
(ii) metadata comprising the encryption/decryption algorithm; and
(b) decrypting the media content in accordance with the encryption/decryption algorithm.

7. The method of claim 6, wherein the first processor is a general purpose digital signal processor (DSP).

8. The method of claim 6, wherein the first processor is an application specific integrated circuit (ASIC).

9. The method of claim 6, further comprising displaying the decrypted media content in a cinema.

10. The method of claim 6, further comprising:
storing the encryption/decryption algorithm; and
receiving an identifier that identifies the encryption/decryption algorithm for specific media content.

11. The method of claim 6, further comprising destroying the encryption/decryption algorithm subsequent to decrypting the media content.

12. The method of claim 6, further comprising receiving and utilizing a different encryption/decryption algorithm for alternative media content.

13. An apparatus for processing digital media content in a computer system, the computer system comprising:
(a) a computer having a memory;
(b) a first general purpose processor and a second co-processor on the computer, wherein the second co-processor is configured to perform common but relatively complex subroutines, and wherein the first processor and second co-processor are configured to:
(i) encrypt the media content into a data file in accordance with an encryption/decryption algorithm;
(ii) insert the encryption/decryption algorithm as metadata into the data file; and
(iii) transmit the data file.

14. The apparatus of claim 13, wherein the first processor is a general purpose digital signal processor (DSP).

15. The apparatus of claim 13, wherein the first processor is an application specific integrated circuit (ASIC).

16. The apparatus of claim 13, wherein the data file is transmitted to a distribution entity for subsequent transmission to a displaying entity.

17. The apparatus of claim 13, wherein the first processor and second co-processor are further configured to:
encrypt the media content in accordance with a different encryption/decryption algorithm; and
insert the different encryption/decryption algorithm into the data file.

18. An apparatus for processing digital media content in a computer system, the computer system comprising:
(a) a computer having a memory;
(b) a first general purpose processor and a second co-processor on the computer, wherein the second co-processor is configured to perform common but relatively complex subroutines, and wherein the first processor and second co-processor are configured to:
(i) receive a data file, wherein the data file comprises:
(1) media content compressed in accordance with an encryption/decryption algorithm, and
(2) metadata comprising the encryption/decryption algorithm; and
(ii) decrypt the media content in accordance with the encryption/decryption algorithm.

19. The apparatus of claim 18, wherein the first processor is a general purpose digital signal processor (DSP).

20. The apparatus of claim 18, wherein the first processor is an application specific integrated circuit (ASIC).

21. The apparatus of claim 18, wherein the decrypted media content is displayed in a cinema.

22. The apparatus of claim 18, wherein:
(a) the encryption/decryption algorithm is stored in the memory of the computer; and
(b) the first processor and second co-processor are further configured to receive an identifier that identifies the encryption/decryption algorithm for specific media content.

23. The apparatus of claim 18, wherein the first processor and second co-processor are further configured to destroy the encryption/decryption algorithm subsequent to decrypting the media content.

24. The apparatus of claim 18, wherein the first processor and second co-processor are configured to receive and utilize a different encryption/decryption algorithm for alternative media content.
